(19) United States
(12) Patent Application Publication
(10) Pub. No.: US 2025/0085507 A1
(43) Pub. Date: Mar. 13, 2025

(54) MIRROR DEVICE AND VEHICLE DISPLAY DEVICE

(71) Applicant: YAZAKI CORPORATION, Tokyo (JP)

(72) Inventors: Yuki Miyoshi, Makinohara-shi (JP); Yasuhiro Katsumata, Makinohara-shi (JP); Naoto Tsubakihara, Makinohara-shi (JP); Hiroshi Sano, Makinohara-shi (JP); Keita Mochizuki, Shimada-shi (JP)

(21) Appl. No.: 18/815,801

(22) Filed: Aug. 26, 2024

(30) Foreign Application Priority Data
Sep. 13, 2023 (JP) 2023-148037

(51) Int. Cl. G02B 7/182; G02B 26/10; G02B 27/01

(52) U.S. Cl. CPC G02B 7/1821; G02B 26/105; G02B 27/0101; G02B 27/0149; G02B 2027/0154

(57) ABSTRACT

A mirror device includes: a mirror that includes a main body having a reflective surface that reflects display light and a rotation shaft protruding from a side wall of the main body; a motor that includes an output shaft disposed on a rotation axis of the rotation shaft; and a power transmission member that transmits a driving force of the motor to the rotation shaft, in which first assembling portions and to be fitted to each other in a direction along the rotation axis at positions adjacent to the rotation shaft are formed at the power transmission member and the mirror.

### CROSS-REFERENCE TO RELATED APPLICATION(S)

The present application claims priority to and incorporates by reference the entire contents of Japanese Patent Application No. 2023-148037 filed in Japan on Sep. 13, 2023.

### BACKGROUND OF THE INVENTION

### 1. Field of the Invention

The present invention relates to a mirror device and a vehicle display device.

### 2. Description of the Related Art

Japanese Patent Application Laid-open No. 2021-167873 discloses a mirror unit including a supported portion in which a pivot center shaft of a mirror holder is pivotably supported by a frame. An outer peripheral surface of the supported portion is a cylindrical surface, and a plurality of radial lightening portions recessed in a radial direction from an outer peripheral surface of the pivot center shaft are formed in a cylindrical surface forming portion which is a portion of the pivot center shaft where the cylindrical surface is formed. With this configuration, in the mirror unit of Japanese Patent Application Laid-open No. 2021-167873, it is possible to suppress a variation in thickness of the entire pivot center shaft even in a case where a length of the pivot center shaft formed in the mirror holder and inserted into a coil spring is large.

By the way, in a mirror device, a time lag may occur between rotation of a motor and rotation of a mirror when changing an angle of the mirror to a predetermined angle by a driving force of the motor due to twisting occurring between a power transmission member that transmits the driving force of the motor to the mirror and the mirror in some cases.

### SUMMARY OF THE INVENTION

An object of the present invention is to provide a mirror device and a vehicle display device that can suppress occurrence of twisting between a power transmission member and a mirror.

In order to achieve the above mentioned object, a mirror device according to one aspect of the present invention includes a mirror that includes a main body having a reflective surface that reflects display light and a rotation shaft protruding from a side wall of the main body; a motor that includes an output shaft disposed on a rotation axis of the rotation shaft; and a power transmission member that transmits a driving force of the motor to the rotation shaft, wherein first assembling portions to be fitted to each other in a direction along the rotation axis at positions adjacent to the rotation shaft are formed at the power transmission member and the mirror.

In order to achieve the above mentioned object, a vehicle display device according to another aspect of the present invention includes a casing that has an opening; an image display device that is provided in the casing and outputs display light for an image; and a mirror device that is provided in the casing, wherein the mirror device includes a mirror that includes a main body having a reflective surface that reflects the display light from the image display device toward the opening, and a rotation shaft protruding from a side wall of the main body, a motor that includes an output shaft disposed on a rotation axis of the rotation shaft, and a power transmission member that transmits a driving force of the motor to the rotation shaft, and first assembling portions to be fitted to each other in a direction along the rotation axis at positions adjacent to the rotation shaft are formed at the power transmission member and the mirror.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating a vehicle on which a vehicle display device according to an embodiment is mounted;

FIG. 2 is a schematic configuration view illustrating the vehicle display device according to the embodiment;

FIG. 3 is a perspective view illustrating a mirror device according to the embodiment;

FIG. 4 is an exploded perspective view illustrating the mirror device according to the embodiment;

FIG. 5 is an exploded perspective view illustrating the mirror device according to the embodiment;

FIG. 6 is a plan view illustrating a power transmission member of the embodiment;

FIG. 7 is an enlarged perspective view illustrating a state in which the power transmission member of the embodiment is attached to a mirror;

FIG. 8 is a cross-sectional view illustrating a state in which the power transmission member of the embodiment is attached to the mirror; and

FIG. 9 is a cross-sectional view illustrating a state in which the mirror device according to the embodiment is assembled to a lower case.

### DETAILED DESCRIPTION OF THE PREFERRED EMBODIMENTS

Hereinafter, a mirror device and a vehicle display device according to an embodiment of the present invention will be described in detail with reference to the drawings. Note that the present invention is not limited by the embodiment. In addition, constituent elements in the following embodiment include those that can be easily assumed by those skilled in the art or those that are substantially the same.

### Embodiment

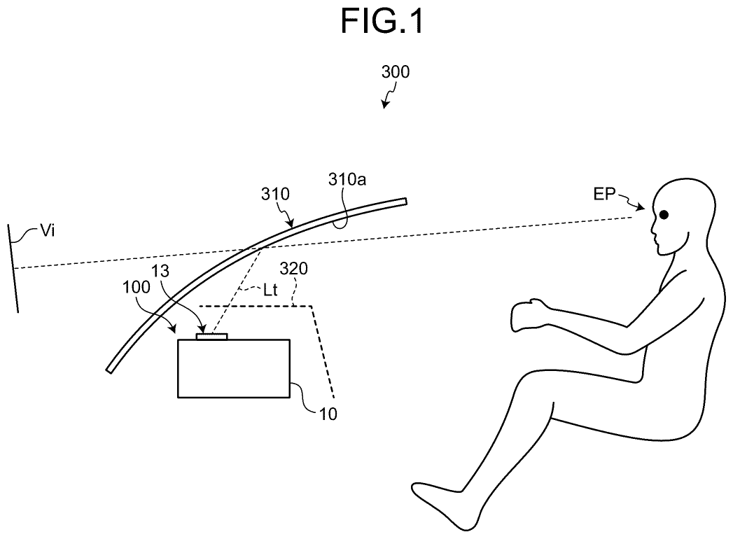

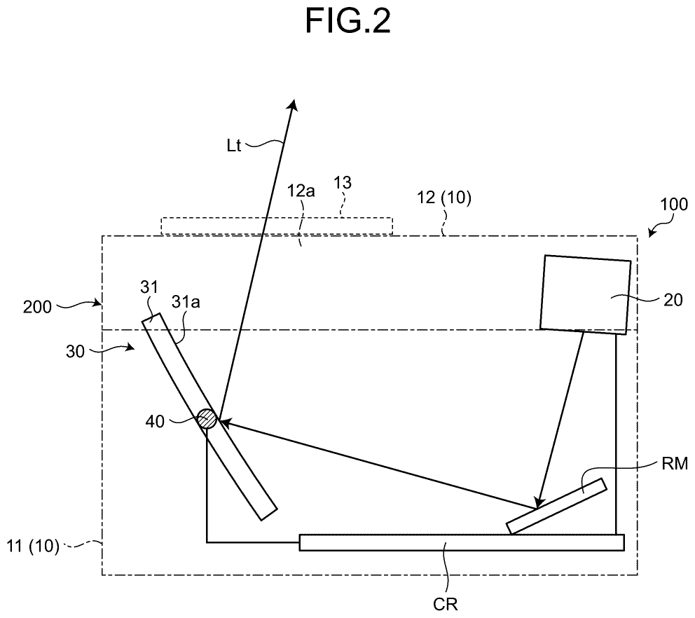

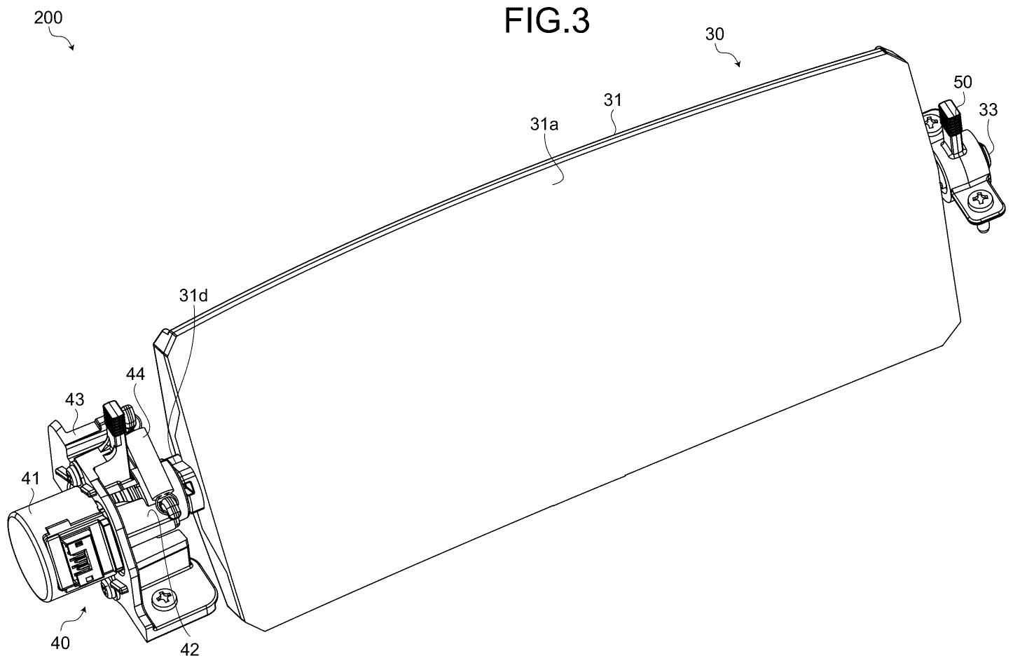

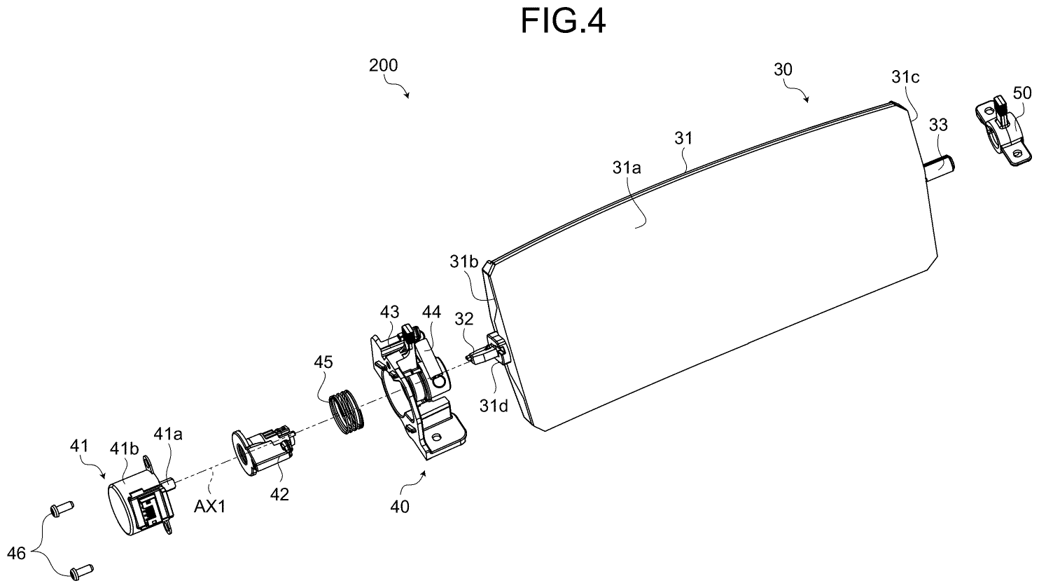

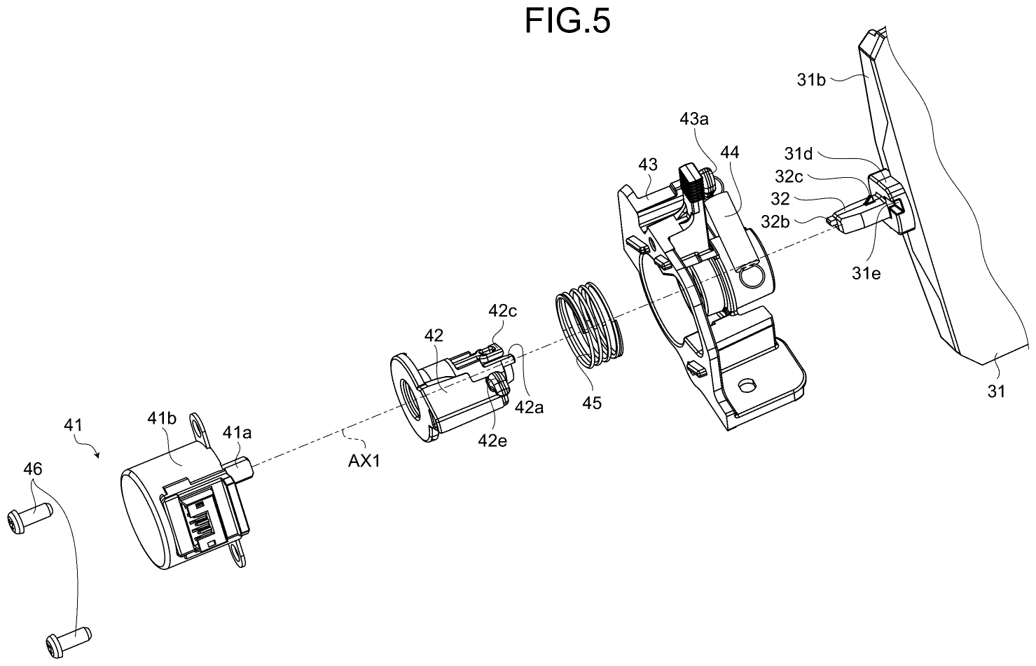

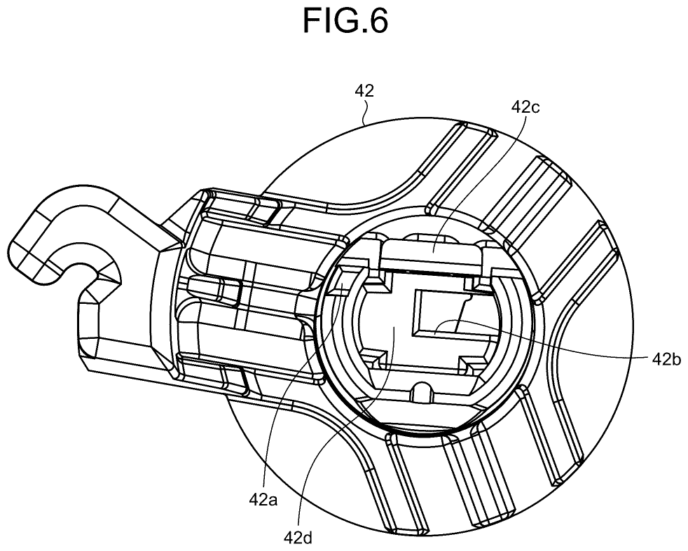

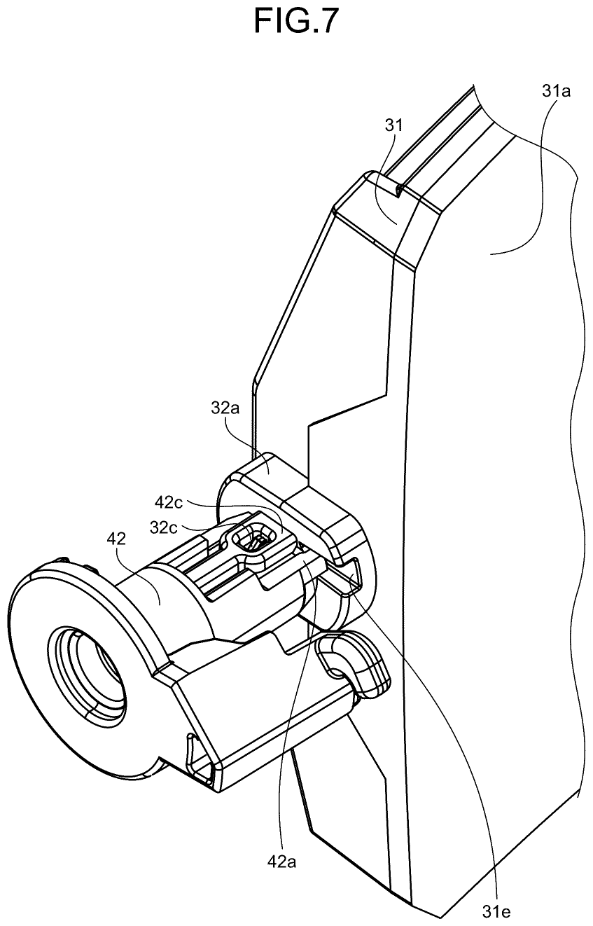

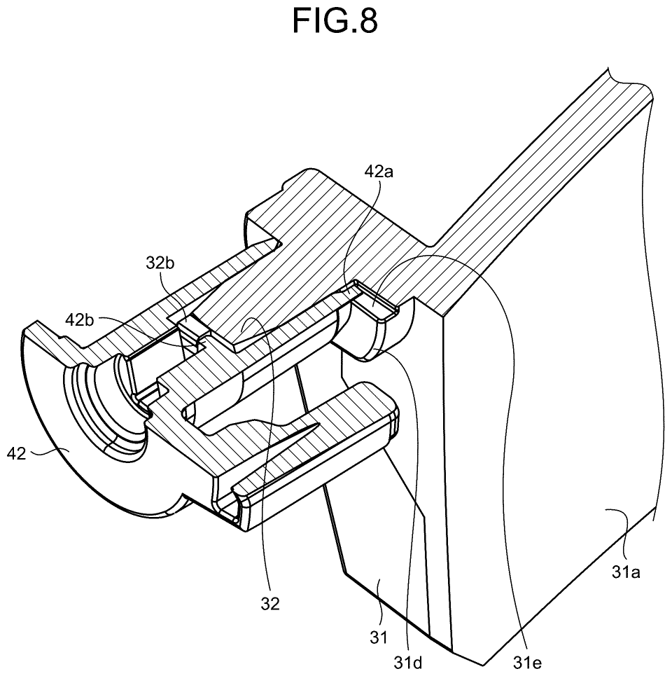

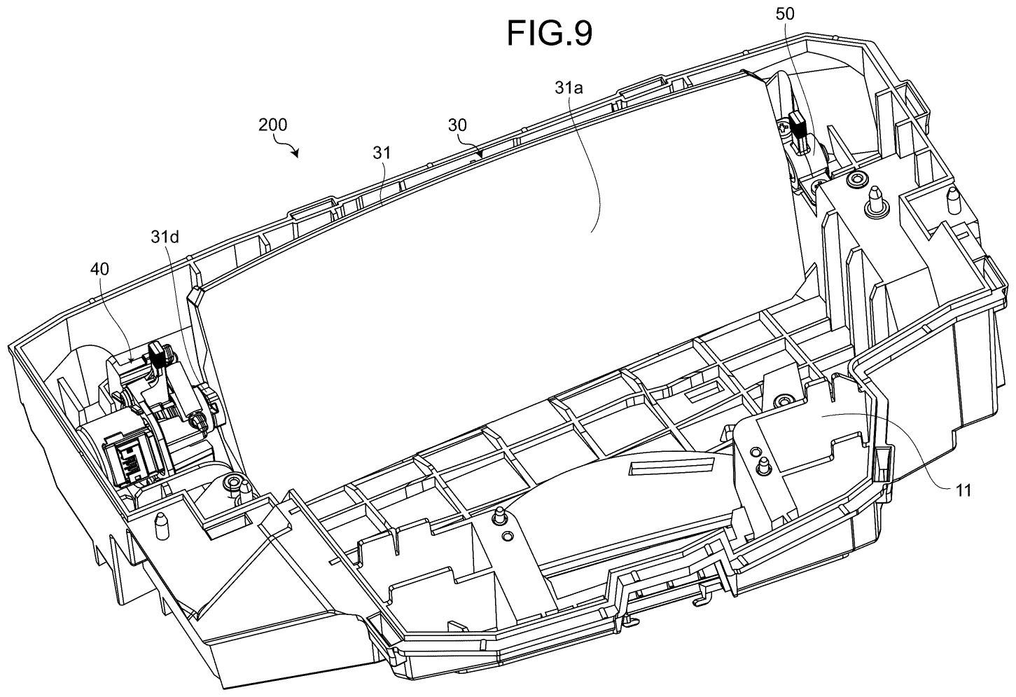

An embodiment will be described with reference to FIGS. 1 to 9. The present embodiment relates to the mirror device and the vehicle display device. FIG. 1 is a view illustrating a vehicle on which the vehicle display device according to the embodiment is mounted, FIG. 2 is a schematic configuration view illustrating the vehicle display device according to the embodiment, FIG. 3 is a perspective view illustrating the mirror device according to the embodiment, FIG. 4 is an exploded perspective view illustrating the mirror device according to the embodiment, FIG. 5 is an exploded perspective view illustrating the mirror device according to the embodiment, FIG. 6 is a plan view illustrating a power transmission member of the embodiment, FIG. 7 is an enlarged perspective view illustrating a state in which the power transmission member of the embodiment is attached to a mirror, FIG. 8 is a cross-sectional view illustrating a state in which the power transmission member of the embodiment is attached to the mirror, and FIG. 9 is a cross-sectional view illustrating a state in which the mirror device according to the embodiment is assembled to a lower case.

A vehicle display device 100 according to the embodiment as illustrated in FIG. 1 is a head-up display device mounted on a vehicle 300 such as an automobile. The vehicle display device 100 is housed in an instrument panel 320 of the vehicle 300. The vehicle display device 100 projects display light Lt for an image toward a reflective surface 310a of a windshield 310 of the vehicle 300 through an opening of the instrument panel 320. The windshield 310 is a reflective portion positioned in front of an eye point EP in the vehicle 300, has semi-transmissivity, for example, and reflects, toward the eye point EP, the display light Lt incident on the reflective surface 310a from the vehicle display device 100. A driver of the vehicle 300 can visually recognize a virtual image Vi by the display light Lt reflected by the windshield 310.

As illustrated in FIG. 2, the vehicle display device 100 includes a casing 10, an image display device 20, a mirror device 200, a reflective member RM, and a control unit CR. The casing 10 is formed in a box shape and is mounted on the vehicle 300. The casing 10 houses the image display device 20, the mirror device 200, the reflective member RM, and the control unit CR in a housing portion HS inside the casing 10. The image display device 20, the mirror device 200, the reflective member RM, and the control unit CR are fixed to the casing 10.

An opening 12a through which the display light Lt is emitted from the inside of the casing 10 toward the reflective surface 310a of the windshield 310 is formed in the casing 10, and a cover member 13 that closes the opening 12a is attached to the casing 10. The cover member 13 is a light transmissive member that transmits at least the display light Lt emitted from the image display device 20.

The casing 10 of the embodiment includes a lower case 11 and an upper case 12. The lower case 11 and the upper case 12 are formed of, for example, an insulating synthetic resin. The lower case 11 is a box-shaped member whose upper side is opened, and the upper case 12 is a box-shaped member whose lower side is opened. The lower case 11 and the upper case 12 are engaged in such a way that an opening of the lower case 11 and an opening of the upper case 12 are aligned with each other to form the casing 10. In the casing 10 of the embodiment, the opening 12a through which the display light Lt is emitted toward the reflective surface 310a of the windshield 310 is formed in an upper surface of the upper case 12. The image display device 20, the mirror device 200, the reflective member RM, and the control unit CR are assembled and held in the lower case 11.

The image display device 20 outputs a display image to be projected onto the windshield 310 as the display light Lt. The image display device 20 includes a liquid crystal display unit and a backlight unit. The liquid crystal display unit is a so-called liquid crystal panel, and includes, for example, a light transmission type or light semi-transmission type thin film transistor (TFT) liquid crystal display. In the liquid crystal display unit, a display surface on a front surface side emits light by being illuminated from a back surface side. The backlight unit illuminates the liquid crystal display unit from the back surface side. The backlight unit is driven by, for example, electric power obtained from a battery (not illustrated) in the vehicle 300.

The reflective member RM is a flat mirror, and a reflective surface that reflects the display light Lt is formed as a flat surface. The reflective member RM is disposed at a position facing the image display device 20. The reflective member RM reflects the display light Lt emitted from the image display device 20 toward a mirror 30 of the mirror device 200.

As illustrated in FIG. 3, the mirror device 200 includes the mirror 30, a drive member 40, and a bearing member 50. The mirror 30 reflects the display light Lt reflected by the reflective member RM toward the reflective surface 310a of windshield 310 through the opening 12a. The mirror 30 of the embodiment is a concave mirror and has a function as a magnifying mirror. That is, the mirror 30 of the embodiment enlarges and reflects the display image in such a way that a display image represented by the display light Lt after being reflected by the concave mirror 30 becomes relatively larger than a display image represented by the display light Lt before being reflected by the mirror 30.

As illustrated in FIG. 4, the mirror 30 includes a main body 31 and rotation shafts 32 and 33. The main body 31 has a reflective surface 31a that reflects the display light Lt. In the embodiment, the main body 31 is a substantially rectangular flat plate-like member whose longitudinal direction is a direction along a rotation axis AX1 when viewed from a thickness direction of the main body 31.

The main body 31 has a first side wall 31b and a second side wall 31c. The first side wall 31b is one side wall in the longitudinal direction of the main body 31, and the second side wall 31c is the other side wall in the longitudinal direction of the main body 31. That is, the main body 31 has the first side wall 31b and the second side wall 31c which is a side wall opposite to the first side wall 31b in the longitudinal direction of the main body 31. In the embodiment, when the mirror 30 is viewed from a reflective surface 31a side, the first side wall 31b is a left side wall of the main body 31, and the second side wall 31c is a right side wall of the main body 31. In the embodiment, a base portion 31d is formed at a part of the first side wall 31b. The base portion 31d is formed at a position where the base portion 31d partially overlaps the rotation axis AX1. The base portion 31d of the embodiment is formed in a cylindrical shape protruding from a surface of the first side wall 31b around the base portion 31d. In the embodiment, a central axis of the base portion 31d is on the rotation axis AX1 of the mirror 30. The rotation axis AX1 is a rotation center of the mirror 30.

The rotation shafts 32 and 33 of the mirror 30 are disposed at positions on the rotation axis AX1. The rotation axis AX1 is the rotation center of the mirror 30. Central axes of the rotation shafts 32 and 33 of the mirror 30 are on the rotation axis AX1.

The rotation shaft 32 is formed on the base portion 31d of the first side wall 31b of the main body 31. The rotation shaft 32 protrudes from the base portion 31d along the rotation axis AX1. The rotation shaft 33 protrudes from the second side wall 31c of the main body 31 along the rotation axis AX1. The drive member 40 is attached to the rotation shaft 32, and the bearing member 50 is attached to the rotation shaft 33. The drive member 40 and the bearing member 50 are fixed to the casing 10 by fixing members such as screws. The mirror 30 is attached to the casing 10 via the drive member 40 and the bearing member 50 (see FIG. 9).

As illustrated in FIG. 4, the drive member 40 includes a motor 41, a power transmission member 42, a motor support 43, a first spring 44, a second spring 45, and a screw 46. The motor 41 includes an output shaft 41a and a motor case 41b.

The motor 41 rotates the output shaft 41a by electric power supplied from the battery or the like of the vehicle. The motor case 41b houses components for rotating the output shaft 41a by consuming supplied electric power, such as a rotor and a stator. In addition, the motor case 41b includes a connector for electrically connection to the control unit and the like.

The control unit CR is connected to the connector of the motor case 41b, and can control the rotation of the output shaft 41a of the motor 41 by controlling the motor 41. For example, the control unit CR can control a rotation speed, a rotation amount, a rotation direction, and the like of the output shaft 41a of the motor 41. The control unit CR can change an angle of the mirror 30 by controlling the rotation of the output shaft 41a of the motor 41.

The power transmission member 42 is a member that connects the output shaft 41a of the motor 41 and the rotation shaft 32 of the mirror 30 and transmits a driving force of the motor 41 to the rotation shaft 32 of the mirror 30. The power transmission member 42 is formed as a tubular member extending along the rotation axis AX1, a first opening into which the rotation shaft 32 is fitted is formed at one end portion of the power transmission member 42, and a second opening into which the output shaft 41a is fitted is formed at the other end portion of the power transmission member 42. Both the first opening and the second opening are positioned on the rotation axis AX1.

As illustrated in FIGS. 4 and 5, the rotation shaft 32 is formed in a prismatic shape extending along the rotation axis AX1, and the first opening of the power transmission member 42 is formed in a shape corresponding to the rotation shaft 32 (that is, a shape to which the rotation shaft 32 can be fitted). The power transmission member 42 is assembled to the mirror 30 in a manner in which the rotation shaft 32 is inserted into the first opening to be fitted into the first opening.

As illustrated in FIG. 5, in the embodiment, first assembling portions 31e and 42a to be fitted to each other in a direction along the rotation axis AX1 at positions adjacent to the rotation shaft 32 are formed at the power transmission member 42 and the mirror 30. The first assembling portions 31e and 42a of the embodiment are implemented by a recess 31e formed in the base portion 31d and a protrusion 42a formed on the power transmission member 42.

The recess 31e of the mirror 30 is a groove-shaped recess formed in the base portion 31d and is formed so as to be fitted to the protrusion 42a as the protrusion 42a of the power transmission member 42 is inserted into the recess 31e along the rotation axis AX1. In the embodiment, the recess 31e is formed at a position adjacent to the rotation shaft 32, and is formed by indenting a part of a surface of the base portion 31d on a motor 41 side toward a side opposite to the motor 41 side. That is, the recess 31e is formed by cutting out a part of an outer peripheral portion of the base portion 31d (a portion of the base portion 31d around the rotation shaft 32).

The protrusion 42a of the power transmission member 42 is provided on an outer peripheral wall portion of the first opening of the power transmission member 42. The protrusion 42a is formed by extending a part of the outer peripheral wall of the first opening toward the mirror 30 along the rotation axis AX1.

In the embodiment, the protrusion 42a has a prismatic shape, and the recess 31e is formed in a shape corresponding to the protrusion 42a. That is, the recess 31e is formed in a shape that can be fitted to the protrusion 42a as the protrusion 42a is inserted into the recess 31e along the rotation axis AX1. The recess 31e and the protrusion 42a are formed to be positioned in such a way that the recess 31e and the protrusion 42a are fitted to each other when the rotation shaft 32 and the power transmission member 42 are assembled in a state in which relative position between the rotation shaft 32 and the power transmission member 42 is a normal position, and the recess 31e and the protrusion 42a are not fitted to each other when the rotation shaft 32 and the power transmission member 42 are about to be assembled in a state in which the relative position between the rotation shaft 32 and the power transmission member 42 is a non-normal position different from the normal position. That is, at the power transmission member 42 and the mirror 30, the first assembling portions 31e and 42a are fitted to each other when the rotation shaft 32 and the power transmission member 42 are assembled in a state in which the relative position between the rotation shaft 32 and the power transmission member 42 is the normal position, and the first assembling portions 31e and 42a are not fitted to each other when the rotation shaft 32 and the power transmission member 42 are about to be assembled in a state in which the relative position between the rotation shaft 32 and the power transmission member 42 is the non-normal position different from the normal position. With this configuration, it is possible to suppress occurrence of erroneous assembly when assembling the power transmission member 42 and the mirror 30.

Here, a case where the relative position between the rotation shaft 32 and the power transmission member 42 is the non-normal position is, for example, a case where a relative positional relationship between the rotation shaft 32 and the power transmission member 42 at the normal position is reversed by 180 degrees about the rotation axis AX1 as a rotation axis. For example, in a case where the relative position between the rotation shaft 32 and the power transmission member 42 is the non-normal position, the first assembling portions 31e and 42a may be formed so as to interfere with a counterpart member (the mirror 30 or the power transmission member 42) to make it impossible to assemble the rotation shaft 32 and the power transmission member 42.

As illustrated in FIGS. 5 and 6, second assembling portions 32b and 42b to be fitted to each other are formed at a distal end portion of the rotation shaft 32 and the power transmission member 42. The second assembling portions 32b and 42b of the embodiment are implemented by a protruding portion 32b formed on the rotation shaft 32 and an opening 42b formed in the power transmission member 42.

As illustrated in FIG. 5, the protruding portion 32b in the embodiment is formed by extending a part of a distal end surface of the rotation shaft 32 toward the motor 41 from the other part of the distal end surface of the rotation shaft 32. The protruding portion 32b is formed in a prismatic shape extending along the rotation axis AX1. In addition, FIG. 6 is a plan view when the power transmission member 42 is viewed from the rotation shaft 32, and a wall portion 42d separating the first opening and the second opening is formed in the power transmission member 42 in the embodiment as illustrated in FIG. 6. The opening 42b of the power transmission member 42 is formed in a part of the wall portion 42d.

As illustrated in FIGS. 7 and 8, the protruding portion 32b and the opening 42b are formed so as to be fitted to each other when the rotation shaft 32 and the power transmission member 42 are assembled at the normal position. FIG. 7 is a cross-sectional view corresponding to FIG. 8, and members other than the mirror 30 and the power transmission member 42 are omitted for the sake of description as in FIG. 7.

Here, the protruding portion 32b and the opening 42b are formed to be positioned in such a way that the protruding portion 32b and the opening 42b are fitted to each other when the rotation shaft 32 and the power transmission member 42 are assembled in a state in which relative position between the rotation shaft 32 and the power transmission member 42 is the normal position, and the protruding portion 32b and the opening 42b are not fitted to each other when the rotation shaft 32 and the power transmission member 42 are about to be assembled in a state in which the relative position between the rotation shaft 32 and the power transmission member 42 is the non-normal position. That is, at the distal end portion of the rotation shaft 32 and the power transmission member 42, the second assembling portions 32b and 42b are fitted to each other when the rotation shaft 32 and the power transmission member 42 are assembled in a state in which the relative position between the rotation shaft 32 and the power transmission member 42 is the normal position, and the second assembling portions 32b and 42b are not fitted to each other when the rotation shaft 32 and the power transmission member 42 are about to be assembled in a state in which the relative position between the rotation shaft 32 and the power transmission member 42 is the non-normal position. Also with this configuration, it is possible to suppress occurrence of erroneous assembly when assembling the power transmission member 42 and the mirror 30. With such a configuration, for example, in a case of erroneously assembling a power transmission member not having the opening 42b (a power transmission member used for a mirror device different from the mirror device 200 according to the embodiment), the assembly of the mirror 30 and the power transmission member is hindered by the protruding portion 32b. With this configuration, occurrence of erroneous assembly is suppressed.

Further, for example, in a case where the relative position between the rotation shaft 32 and the power transmission member 42 is the non-normal position, the second assembling portions 32b and 42b may be formed so as to interfere with a counterpart member (the mirror 30 or the power transmission member 42) to make it impossible to assemble the rotation shaft 32 and the power transmission member 42.

As illustrated in FIGS. 5 and 7, third assembling portions 32c and 42c engaged with each other are formed at the rotation shaft 32 and the power transmission member 42. The third assembling portions 32c and 42c of the embodiment are formed by a locking claw 32c formed on the rotation shaft 32 and a locking arm 42c formed on the power transmission member 42. In FIG. 7, members other than the mirror 30 and the power transmission member 42 are omitted for the sake of description.

The locking claw 32c is a protrusion portion formed on a side surface (a surface in a direction orthogonal to the rotation axis AX1) of the rotation shaft 32, and is formed to be engaged with the locking arm 42c. The locking claw 32c is formed by protruding from a surface around the rotation shaft 32. As illustrated in FIG. 5, in the embodiment, the locking claw 32c is formed on a surface of the rotation shaft 32 that faces upward.

The locking arm 42c is a portion that is a part of a side wall of the first opening of the power transmission member 42, and includes a leaf-spring shaped arm portion and a frame-shaped locking portion provided at a distal end of the arm portion. When the rotation shaft 32 and the power transmission member 42 are assembled, the locking portion of the locking arm 42c gets over the locking claw 32c, and when the assembling of the rotation shaft 32 and the power transmission member 42 is completed, the locking claw 32c is disposed inside the frame-shaped locking portion, so that the locking arm 42c and the locking claw 32c are engaged with each other (see FIG. 7).

At the rotation shaft 32 and the power transmission member 42, the third assembling portions 32c and 42c are fitted to each other when the rotation shaft 32 and the power transmission member 42 are assembled in a state in which the relative position between the rotation shaft 32 and the power transmission member 42 is the normal position, and the third assembling portions 32c and 42c are not fitted to each other when the rotation shaft 32 and the power transmission member 42 are about to be assembled in a state in which the relative position between the rotation shaft 32 and the power transmission member 42 is the non-normal position. Also with this configuration, it is possible to suppress occurrence of erroneous assembly when assembling the power transmission member 42 and the mirror 30.

Further, for example, in a case where the relative position between the rotation shaft 32 and the power transmission member 42 is the non-normal position, the third assembling portions 32c and 42c may be formed so as to interfere with a counterpart member (the mirror 30 or the power transmission member 42) to make it impossible to assemble the rotation shaft 32 and the power transmission member 42.

Further, for example, in a case of erroneously assembling a power transmission member not including the locking arm 42c (a power transmission member used for a mirror device different from the mirror device 200 according to the embodiment), the assembly of the mirror 30 and the power transmission member is hindered by the locking claw 32c. With this configuration, occurrence of erroneous assembly is suppressed.

The motor support 43 is a member that is fixed to the casing 10 (see FIG. 8) while supporting the motor 41. The motor support 43 is formed so as to cover the power transmission member 42. In the embodiment, an insertion hole into which the power transmission member 42 is inserted is formed in the motor support 43. The insertion hole is opened in the direction along the rotation axis AX1.

The power transmission member 42 is inserted into the insertion hole of the motor support 43 from a side of the motor support 43 that is opposite to the main body 31 of the mirror 30. The power transmission member 42 inserted into the insertion hole is held in the motor support 43 in a state where a distal end (an end portion on a main body 31 side) of the power transmission member 42 protrudes from the insertion hole of the motor support 43.

The first assembling portions 31e and 42a of the power transmission member 42 are exposed to the outside from the motor support 43, and whether or not the recess 31e and the protrusion 42a as the first assembling portions 31e and 42a are fitted to each other can be visually checked from the outside.

As illustrated in FIG. 4, the motor 41 is attached to and held by the motor support 43 on the power transmission member 42. The motor 41 is fixed to the motor support 43 by the screw 46. The motor 41 and the motor support 43 are fixed by the screw 46, whereby the power transmission member 42 is also fixed in a state of being housed inside the motor support 43.

In the embodiment, hook portions 42e and 43a are provided in the power transmission member 42 and the motor support 43, respectively. The hook portion 42e of the power transmission member 42 is exposed from the motor support 43. The first spring 44 is a stretchable coil-shaped spring, and ring portions are provided at both ends of the first spring 44. One ring portion of the first spring 44 is attached to the hook portion 42e of the power transmission member 42, and the other ring portion of the first spring 44 is attached to the hook portion 43a of the motor support 43. The first spring 44 suppresses rattling between the power transmission member 42 and the motor support 43 by a contraction force of the spring.

The second spring 45 is a stretchable coil-shaped spring. In the embodiment, a flange portion is formed at an end portion of the power transmission member 42 on a side opposite to the main body 31 of the mirror 30, and the flange portion faces the motor support 43 in the direction along the rotation axis AX1. The second spring 45 is provided between the flange portion of the power transmission member 42 and the motor support 43, and suppresses rattling between the power transmission member 42 and the motor support 43.

As illustrated in FIG. 4, the drive member 40 is attached to the rotation shaft 32, and the bearing member 50 is attached to the rotation shaft 33. The mirror 30 is attached to the lower case 11 via the drive member 40 and the bearing member 50. For example, the drive member 40 and the bearing member 50 are fixed to the lower case by the fixing members such as screws.

The control unit CR controls the image display device 20 to perform display control of the display image (virtual image) displayed by the vehicle display device 100 (see FIG. 2). The control unit CR is also connected to the mirror device 200, and can adjust an angle of the main body 31 of the mirror 30 by controlling the rotation of the motor 41 of the mirror device 200. That is, the control unit CR can control the mirror device 200 to adjust a display position of the display image.

As described above, the mirror device 200 according to the embodiment includes the mirror 30 including the main body 31 having the reflective surface 31a that reflects the display light Lt and the rotation shaft 32 protruding from the side wall of the main body 31, the motor 41 including the output shaft 41a disposed on the rotation axis AX1 of the rotation shaft 32, and the power transmission member 42 that transmits the driving force of the motor 41 to the rotation shaft 32. The first assembling portions 31e and 42a to be fitted to each other in the direction along the rotation axis AX1 at the positions adjacent to the rotation shaft 32 are formed at the power transmission member 42 and the mirror 30.

In the mirror device 200 according to the embodiment, the first assembling portions (the recess 31e and the protrusion 42a) to be fitted to each other in the direction along the rotation axis AX1 at the positions adjacent to the rotation shaft 32 are formed at the power transmission member 42 and the mirror 30. That is, in the embodiment, the first assembling portions (the recess 31e and the protrusion 42a) are provided at positions shifted from the rotation axis AX1 which is the rotation center (that is, positions outside the rotation axis AX1). Since the first assembling portions (the recess 31e and the protrusion 42a) are fitted outside the rotation axis AX1, it is possible to suppress twisting of a portion outside the rotation center with respect to the rotation center (the rotation axis AX1) when the mirror 30 of the mirror device 200 rotates (when the angle of the mirror 30 is changed to a predetermined angle by the driving force of the motor 41). In addition, since the first assembling portions (the recess 31e and the protrusion 42a) are provided separately from the rotation shaft 32, the power transmission member 42 and the mirror 30 are more firmly connected than in a case where the power transmission member 42 and the mirror 30 are connected only by the rotation shaft 32. Therefore, when the angle of the mirror 30 is changed to a predetermined angle by the driving force of the motor 41, it is possible to suppress occurrence of twisting between the power transmission member 42 and the mirror 30. Therefore, it is possible to suppress occurrence of a time lag between the rotation of the motor and the rotation of the mirror due to the twisting between the power transmission member 42 and the mirror 30. Further, in the mirror device 200, the driving force of the motor 41 can be smoothly transmitted to the mirror 30 by suppressing the twisting between the power transmission member 42 and the mirror 30, so that driving efficiency of the motor 41 can be improved.

In the mirror device 200 according to the embodiment, at the power transmission member 42 and the mirror 30, the first assembling portions 31e and 42a are fitted to each other when the rotation shaft 32 and the power transmission member 42 are assembled in a state in which the relative position between the rotation shaft 32 and the power transmission member 42 is the normal position, and the first assembling portions 31e and 42a are not fitted to each other when the rotation shaft 32 and the power transmission member 42 are about to be assembled in a state in which the relative position between the rotation shaft 32 and the power transmission member 42 is the non-normal position.

In the mirror device 200 according to the embodiment, the first assembling portions 31e and 42a are fitted to each other when the rotation shaft 32 and the power transmission member 42 are assembled in a state in which the relative position between the rotation shaft 32 and the power transmission member 42 is the normal position, and the first assembling portions 31e and 42a are not fitted when the rotation shaft 32 and the power transmission member 42 are about to be assembled in a state in which the relative position between the rotation shaft 32 and the power transmission member 42 is the non-normal position. Therefore, it is possible to suppress occurrence of erroneous assembly when assembling the mirror 30 and the power transmission member 42.

Further, in the mirror device 200 according to the embodiment, the second assembling portions 32b and 42b to be fitted to each other are formed at the distal end portion of the rotation shaft 32 and the power transmission member 42, and in the distal end portion of the rotation shaft 32 and the power transmission member 42, the second assembling portions 32b and 42b are fitted to each other when the rotation shaft 32 and the power transmission member 42 are assembled in a state in which the relative position between the rotation shaft 32 and the power transmission member 42 is the normal position, and the second assembling portions 32b and 42b are not fitted to each other when the rotation shaft 32 and the power transmission member 42 are about to be assembled in a state in which the relative position between the rotation shaft 32 and the power transmission member 42 is the non-normal position.

In the mirror device 200 according to the embodiment, since the second assembling portions 32b and 42b are fitted to each other only when the rotation shaft 32 and the power transmission member 42 are assembled in a state in which the relative position between the rotation shaft 32 and the power transmission member 42 is the normal position, it is possible to suppress occurrence of erroneous assembly when assembling the mirror 30 and the power transmission member 42. In addition, as the second assembling portions 32b and 42b are provided together with the first assembling portions 31e and 42a, the function of suppressing erroneous assembly can be further improved.

The vehicle display device 100 according to the embodiment includes the casing 10 that has the opening, the image display device 20 that is provided in the casing 10 and outputs the display light Lt for an image, and the mirror device 200 that is provided in the casing 10, in which the mirror device 200 includes the mirror 30 that includes the main body 31 having the reflective surface 31a that reflects the display light Lt from the image display device 20 toward the opening, and the rotation shaft 32 protruding from the side wall of the main body 31, the motor 41 that includes the output shaft 41a disposed on the rotation axis AX1 of the rotation shaft 32, and the power transmission member 42 that transmits the driving force of the motor 41 to the rotation shaft 32, and the first assembling portions 31e and 42a to be fitted to each other in the direction along the rotation axis AX1 at the positions adjacent to the rotation shaft 32 are formed at the power transmission member 42 and the mirror 30.

In the vehicle display device 100 according to the embodiment, the first assembling portions (the recess 31e and the protrusion 42a) to be fitted to each other in the direction along the rotation axis AX1 at the positions adjacent to the rotation shaft 32 are formed at the power transmission member 42 and the mirror 30. That is, in the embodiment, the first assembling portions (the recess 31e and the protrusion 42a) are provided at positions shifted from the rotation axis AX1 which is the rotation center (that is, positions outside the rotation axis AX1). Since the first assembling portions (the recess 31e and the protrusion 42a) are fitted outside the rotation axis AX1, it is possible to suppress twisting of a portion outside the rotation center with respect to the rotation center (the rotation axis AX1) when the mirror 30 of the mirror device 200 rotates (when the angle of the mirror 30 is changed to a predetermined angle by the driving force of the motor 41). In addition, since the first assembling portions (the recess 31e and the protrusion 42a) are provided separately from the rotation shaft 32, the power transmission member 42 and the mirror 30 are more firmly connected than in a case where the power transmission member 42 and the mirror 30 are connected only by the rotation shaft 32. Therefore, when the angle of the mirror 30 is changed to a predetermined angle by the driving force of the motor 41, it is possible to suppress occurrence of twisting between the power transmission member 42 and the mirror 30. Therefore, it is possible to suppress occurrence of a time lag between the rotation of the motor and the rotation of the mirror due to the twisting between the power transmission member 42 and the mirror 30. Further, in the vehicle display device 100, the driving force of the motor 41 can be smoothly transmitted to the mirror 30 by suppressing the twisting between the power transmission member 42 and the mirror 30, so that driving efficiency of the motor 41 can be improved.

### Modified Example

In the above-described embodiment, an example in which the first assembling portions are implemented by the recess 31e formed in the base portion 31d and the protrusion 42a formed on the power transmission member 42 has been described, but the present invention is not limited to this configuration. For example, the first assembling portions may be implemented by a protrusion formed on the base portion 31d and a recess formed in the power transmission member 42. With such a configuration, for example, in a case of erroneously assembling a power transmission member not having the recess (a power transmission member used for a mirror device different from the mirror device 200 according to the embodiment), the assembly of the mirror 30 and the power transmission member is hindered by the protrusion of the base portion 31d. With this configuration, occurrence of erroneous assembly is suppressed.

In addition, in the above-described embodiment, an example in which the second assembling portions are implemented by the protruding portion 32b formed on the rotation shaft 32 and the opening 42b formed in the power transmission member 42 has been described, but the present invention is not limited to this configuration. For example, the second assembling portions may be implemented by a recess formed in the rotation shaft 32 and a protruding portion formed on the wall portion 42d of the power transmission member 42.

Further, in the above-described embodiment, a configuration in which the base portion 31d and the rotation shaft 32 are provided on the first side wall 31b of the main body 31 and the rotation shaft 33 is provided on the second side wall 31c of the main body 31 has been described as an example, but the present invention is not limited to this configuration. For example, the base portion 31d and the rotation shaft 32 may be provided on the second side wall 31c of the main body 31, and the rotation shaft 33 may be provided on the first side wall 31b of the main body 31. In this case, a shape of the power transmission member 42 suitable for the configuration in which the base portion 31d and the rotation shaft 32 are provided on the first side wall 31b and a shape of the power transmission member 42 suitable for the configuration in which the base portion 31d and the rotation shaft 32 are provided on the second side wall 31c are in a reflection symmetric relationship with each other. Therefore, for example, in a case where the power transmission member 42 suitable for the configuration in which the base portion 31d and the rotation shaft 32 are provided on the first side wall 31b is about to be assembled to the rotation shaft 32 of the mirror 30 for the configuration in which the base portion 31d and the rotation shaft 32 are provided on the second side wall 31c, the first assembling portions (the recess 31e and the protrusion 42a), the second assembling portions (32b and 42b), or the third assembling portions (32c and 42c) are not fitted to each other, and thus, the assembly of the mirror 30 and the power transmission member 42 is hindered. That is, since the assembly of the mirror 30 and the power transmission member 42 which are not a proper combination is hindered, so that occurrence of erroneous assembly is suppressed. Similarly, in a case where the power transmission member 42 suitable for the configuration in which the base portion 31d and the rotation shaft 32 are provided on the second side wall 31c is about to be assembled to the rotation shaft 32 of the mirror 30 for the configuration in which the base portion 31d and the rotation shaft 32 are provided on the first side wall 31b, the first assembling portions (the recess 31e and the protrusion 42a), the second assembling portions (32b and 42b), or the third assembling portions (32c and 42c) are not fitted to each other, and thus, the assembly of the mirror 30 and the power transmission member 42 is hindered, so that occurrence of erroneous assembly is suppressed.

In the above-described embodiment, the configuration in which the image display device 20, the mirror device 200, the reflective member RM, and the control unit CR are assembled to the lower case 11 has been described as an example, but the present invention is not limited to this configuration. For example, the image display device 20, the mirror device 200, the reflective member RM, and the control unit CR may be assembled to the upper case 12.

The contents disclosed in the above embodiment can be appropriately combined and executed.

The mirror device and the vehicle display device according to the present embodiment have an effect of suppressing occurrence of twisting between the power transmission member and the mirror.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mirror device comprising:
a mirror that includes a main body having a reflective surface that reflects display light and a rotation shaft protruding from a side wall of the main body;
a motor that includes an output shaft disposed on a rotation axis of the rotation shaft; and
a power transmission member that transmits a driving force of the motor to the rotation shaft, wherein
first assembling portions to be fitted to each other in a direction along the rotation axis at positions adjacent to the rotation shaft are formed at the power transmission member and the mirror.

2. The mirror device according to claim 1, wherein
at the power transmission member and the mirror, the first assembling portions are fitted to each other when the rotation shaft and the power transmission member are assembled in a state in which a relative position between the rotation shaft and the power transmission member is a normal position, and the first assembling portions are not fitted to each other when the rotation shaft and the power transmission member are about to be assembled in a state in which the relative position between the rotation shaft and the power transmission member is a non-normal position.

3. The mirror device according to claim 1, wherein
second assembling portions to be fitted to each other are formed at a distal end portion of the rotation shaft and the power transmission member, and
at the distal end portion of the rotation shaft and the power transmission member, the second assembling portions are fitted to each other when the rotation shaft and the power transmission member are assembled in a state in which a relative position between the rotation shaft and the power transmission member is a normal position, and the second assembling portions are not fitted to each other when the rotation shaft and the power transmission member are about to be assembled in a state in which the relative position between the rotation shaft and the power transmission member is a non-normal position.

4. The mirror device according to claim 2, wherein
second assembling portions to be fitted to each other are formed at a distal end portion of the rotation shaft and the power transmission member, and
at the distal end portion of the rotation shaft and the power transmission member, the second assembling portions are fitted to each other when the rotation shaft and the power transmission member are assembled in a state in which a relative position between the rotation shaft and the power transmission member is a normal position, and the second assembling portions are not fitted to each other when the rotation shaft and the power transmission member are about to be assembled in a state in which the relative position between the rotation shaft and the power transmission member is a non-normal position.

5. A vehicle display device comprising:
a casing that has an opening;
an image display device that is provided in the casing and outputs display light for an image; and
a mirror device that is provided in the casing, wherein
the mirror device includes
a mirror that includes a main body having a reflective surface that reflects the display light from the image display device toward the opening, and a rotation shaft protruding from a side wall of the main body,
a motor that includes an output shaft disposed on a rotation axis of the rotation shaft, and
a power transmission member that transmits a driving force of the motor to the rotation shaft, and
first assembling portions to be fitted to each other in a direction along the rotation axis at positions adjacent to the rotation shaft are formed at the power transmission member and the mirror.
